(19) United States
(12) Patent Application Publication
(10) Pub. No.: US 2015/0104065 A1
(43) Pub. Date: Apr. 16, 2015

(54) APPARATUS AND METHOD FOR RECOGNIZING OBJECT IN IMAGE

(71) Applicant: Electronics and Telecommunications Research Institute, Daejeon (KR)

(72) Inventors: So-Yung PARK, Daejeon (KR); Kee-Seong CHO, Daejeon (KR); Won RYU, Seoul (KR); Jae-Cheol SIM, Daejeon (KR); Cho-Rong YU, Daejeon (KR); Won-Il CHANG, Daejeon (KR)

(21) Appl. No.: 14/497,489

(22) Filed: Sep. 26, 2014

(30) Foreign Application Priority Data
Oct. 15, 2013 (KR) 10-2013-0122698
May 12, 2014 (KR) 10-2014-0056818

(51) Int. Cl. G06K 9/62; G06K 9/00

(52) U.S. Cl. CPC G06K 9/6202; G06K 9/00624
USPC 382/103

(57) ABSTRACT

An apparatus and method for recognizing an object are provided. The apparatus includes an input component configured to receive an input image that includes a target object, and a processor configured to recognize a target object in the received image using image-object correlation information that represents a correlation between an image and an object.

### CROSS-REFERENCE TO RELATED APPLICATION(S)

This application claims priority from Korean Patent Application Nos. 10-2013-0122698, filed on Oct. 15, 2013, and 10-2014-0056818, filed on May 12, 2014, in the Korean Intellectual Property Office, the disclosures of which are incorporated herein by references in its entirety.

### BACKGROUND

1. Field

The following description relates to a broadcast communication, and more particularly, to recognition of objects in an image.

2. Description of the Related Art

is Object recognition for recognizing objects in an image is utilized in a computer vision field, etc. An image refers to both a still image and a video. The object recognition process may include detection process and identification process. The detection process is to identify a category to which an object belongs, and the identification process is to obtain unique identification information of the object. For example, in a case of recognizing a person in an image, identifying whether the person is a female or male is relevant to detection and identifying that the persons is named “HONG, Gildong” is relevant to identification. The detection and identification may be performed sequentially, or only the identification may be carried out without detection process, depending on the recognition method.

Detection and identification of an object may be executed by a detector and an identifier, respectively. The detection and identification are collectively referred to as recognition and the detector and identifier are also collectively referred to as a recognizer. Development of the object recognizer comprises several stages including: image dataset establishment, method planning for extracting feature points of objects in an image, recognition model designing, recognizer performance evaluation, and the like. The image dataset includes a training set which is an image database needed for training the recognizer, and a test set which is an image database needed for evaluating the performance of a recognizer developed through training.

Based on a designed method of extracting feature points of an object in the image, features of the image in the dataset may be represented as feature point vectors and the development of the recognizer is performed based on the feature point vectors. Then, a recognition model is designed to classify the object into a suitable category. The recognition model is generated by mathematically modeling criteria for classifying an image. In response to selection of a recognition model, learning based on the image dataset is performed. Then, performance of the recognizer developed through the above processes is evaluated. To develop a recognizer with high performance, it is needed to establish a dataset composing well-refined images, design a method of representing features for effectively showing characteristics of an image, and design and learn models for efficient object recognition.

### SUMMARY

In one general aspect, there is provided an apparatus for recognizing an object, including: an input component configured to receive an input image including a target object; and a processor configured to recognize a target object in the received image using image-object correlation information that represents a correlation between an image and an object.

The image-object correlation information may be information generated from data about an image and data about an object in the image, and include image-related information, object information about an object likely to be present in an image, and probability information about a likelihood of a predetermined object being present in a predetermined image.

The processor may modify object identifiers to reflect image-object correlation information and identify the target object in the image using the modified object identifiers. The processor may adjust an object-identification result to reflect the image-object correlation information. The processor may identify the target object using the object identifiers, and produce a final object-identification result by adjusting the object-identification result to reflect the image-object correlation information.

The processor may model the object identifiers into a plurality of groups using the image-object correlation information. In this case, the processor may differentiate importance of the groups from one another, and identify the target object sequentially using object identifiers of each group according to priority of groups. The processor may differentiate importance of the groups from one another, and identify the target object in a constrained manner that only uses object identifiers belonging to a designated group.

In another general aspect, there is provided an apparatus for recognizing an object, including: an image acquiring component configured to acquire an image that includes a target object; an object detecting component configured to detect an object in the image acquired by the image acquiring component; an information-processing component configured to acquire data about an image and data about an object in the image and generate image-object correlation information that represents a correlation between the image and an object; and an object identifying component configured to receive an object-detection result from the object detecting component, receive the image-object correlation information from the information-processing component, and identify the target object using the received object-detection result and image-object correlation information.

The information-processing component may include a data collector configured to collect data about an image and data about an object in the image, an information generator configured to generate the image-object correlation information by processing the data collected by the data collector, and an information provider configured to provide the generated image-object correlation information to the object identifying component.

The information processing component may select image-object correlation information needed for object identification by the object identifying component from among previously stored image-object correlation information, and provide the selected image-object correlation information to the object identifying component.

The information processing component may receive image metadata of the image that includes the target object from the image acquiring component, receive the object-detection result from the object detecting component, and select the image-object correlation information to be provided to the object identifying component using the received image metadata and image-object correlation information.

The object identifying component may include an information receiver configured to receive the image-object correlation information from the information processing component and modify object identifiers to reflect the received image-object correlation information and an object identification executing component to identify the target object using the object identifiers modified by the information receiver.

The object identifying component may include an object identification executing component configured to identify an object using object identifiers, and an information receiver configured to receive the image-object correlation information from the information processing component and produce a final identification result by adjusting an object identification result from the object identification executing component to reflect the received image-object correlation information.

In another general aspect, there is provided a method of recognizing an object, including: acquiring an image that includes a target object; detecting an object in the acquired image; generating image-object correlation information that represents a correlation between an image and an object; and identifying the target object using an object detection result and the image-object correlation information.

The identifying of the target object may include receiving the image-correlation information, modifying object identifiers to reflect the received image-object correlation information and identifying the target object using the modified object identifiers.

The identifying of the target object may include identifying objects in the image using object identifiers, receiving the image-object correlation information, and producing a final identification result by adjusting an object identification result to reflect the received image-object correlation information.

Other features and aspects will be apparent from the following detailed description, the drawings, and the claims.

### BRIEF DESCRIPTION OF THE DRAWINGS

FIG. 1 is a diagram illustrating an apparatus for recognizing an object according to an exemplary embodiment.

FIG. 2 is a diagram illustrating an apparatus for recognizing an object according to another exemplary embodiment.

FIG. 3 is a diagram illustrating in detail the information-processing component of FIG. 2.

FIG. 4 is a diagram illustrating in detail the object identifying component of FIG. 2.

FIG. 5 is a diagram to explain an example of object identification by modifying object identifiers using image-object correlation information according to an exemplary embodiment.

FIG. 6 is a diagram explaining an example of a result of object identification using object identifiers modified using image-object correlation information according to exemplary embodiment.

FIG. 7 is a diagram explaining an example of adjusting an object-recognition result using image-object correlation information according to an exemplary embodiment.

FIG. 8 is a flowchart illustrating a method for recognizing an object according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

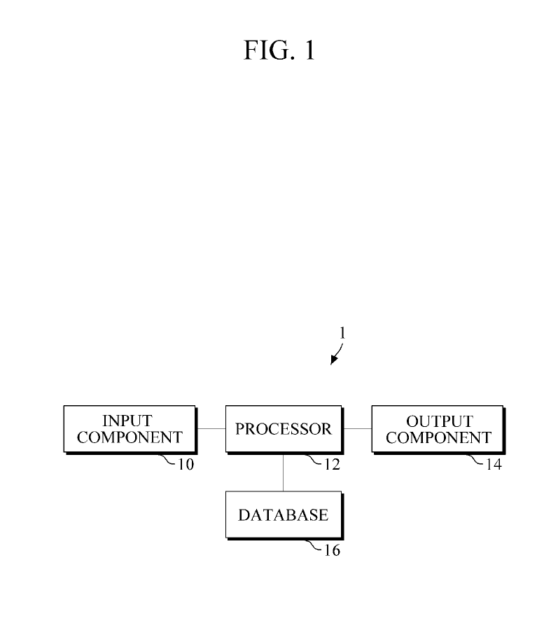

FIG. 1 is a diagram illustrating an apparatus for recognizing an object according to an exemplary embodiment.

Referring to FIG. 1, the apparatus 1 includes an input component 10, a processor 12, an output component 14, and a database 16.

The input component 10 receives an input user instruction to recognize an object in an image. The input component 10 may receive an input request from an external requester to recognize an object. In addition, the input component 10 receives an input image that contains a target object to be recognized. The received image may include an image and image metadata. The input component 10 may receive an image from an image provider. The image provider may be located outside of the apparatus 1, and in this case, the image may be input from the image provider via means of communication.

The processor 12 may recognize the target object from the image received from the input component 10. Here, “recognition” refers to both detection and identification. In one example, the processor 12 may recognize the target object in an image using image-object correlation information that represents a correlation between an image and an object. The image-object correlation information is generated by processing image data and object data regarding the object in the image, and includes image-related information, object information about an object likely to be present in the image, probability information about a probability of a predetermined object being present in a predetermined image, and the like. The correlation may include a hierarchical relation, an inclusion relation, a parallel or associative relation, an ownership or membership, and the like.

In the process of identifying a target object in an image, the target object is identified using not only a previously trained recognition model but also the image-object correction information, so that time taken to recognize the object can be reduced and the accuracy of recognition can be increased. For example, by using the image-object correlation information, thereby limiting a range of the target object, the object recognition time can be reduced. In another example, the image-object correlation information is reflected in the object recognition result, so that the accuracy of the object recognition can be improved.

The processor 12 modifies object identifiers to reflect the image-object correlation, and identifies the target object in the image using the modified object identifier. The object identifier is a value that allows the corresponding object to be distinguished from other objects. In another example, the processor 12 may adjust an object recognition result to reflect the image-object correlation information. More specifically, the processor 12 may identify a target object using object identifiers, and produce a final object-identification result by adjusting the identification result to reflect the image-object correlation. For example, the identification result may be adjusted to reflect the probability of the target object being present within the image, so that the final object-identification is produced.

The output component 14 may output a processing result of the processor 12, which may be an object recognition result. The database 16 may store various data required for executing operation of the processor 12, and the data may include image metadata, object identifiers, image-object correlation information, object recognition result, and the like.

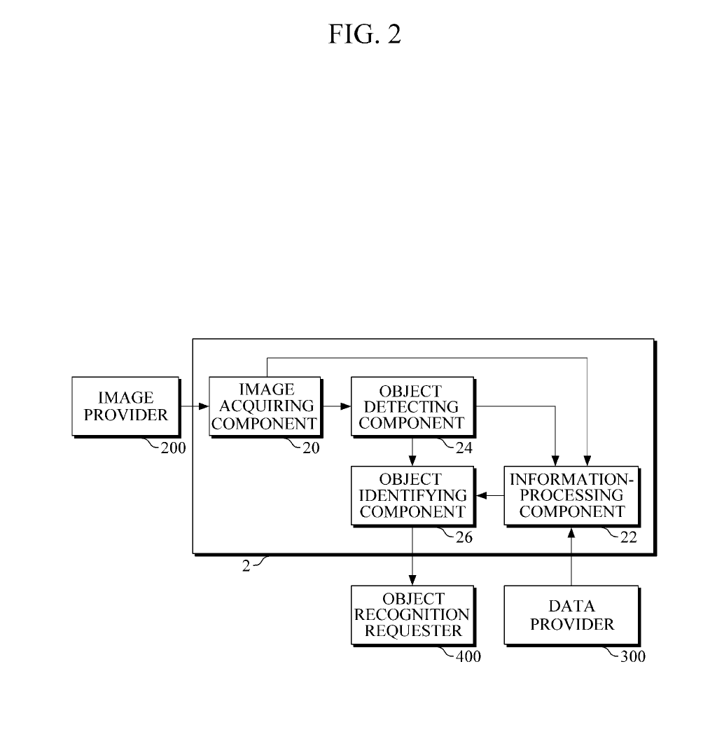

FIG. 2 is a diagram illustrating an apparatus for recognizing an object according to another exemplary embodiment.

Referring to FIG. 2, the apparatus 2 includes an image acquiring component 20, an information-processing component 22, an object detecting component 24, and an object identifying component 26. The apparatus 2 shown in FIG. 2 may be equivalent to the processor 12 of FIG. 1.

The image acquiring component 20 acquires an image from the image provider 200. Then, the image acquiring component 20 separates the image itself from the image metadata, and provides the image to the object detecting component 24 and the image metadata to the information-processing component 22. The image provider may be located externally from the apparatus 2.

The information-processing component 22 searches or receives the image-object correlation data and generates image-object correlation information by processing the image-object correlation data. Then, the information-processing component 22 provides the generated image-object information to the object identifying component 26. The image-object correlation data includes data related to the image, data related to objects that are likely to be present in the image, and the like. The information-processing component 22 may receive the image-object correlation data from the data provider 300. The data provider 300 may be located on an external web server.

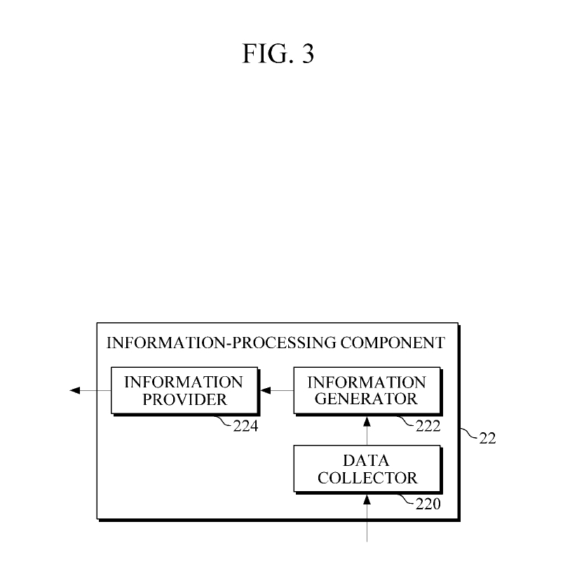

The information-processing component 22 may access the image-object correlation data through visual, audible, or sensory content, a descriptor, or the like. For example, the image-object correlation data may be presented in various forms, such as an image, text, streaming or non-streaming video, streaming or non-streaming audio, universal resource locator (URL), wireless application protocol (WAP) page, a Hyper Text Markup Language (HTML) page, an Extensible Markup Language (XML) document, an executable program, a file name, an Internet protocol (IP) address, telephone call, and the like. Detailed configuration and operation of the information-processing component 22 will be described with reference to FIG. 3.

The object detecting component 24 receives the image from the image acquiring component 20, and then detects an object present in the received image. Thereafter, the object detecting component 24 provides the detection result to the object identifying component 26, and may also provide it to the information-processing unit 22.

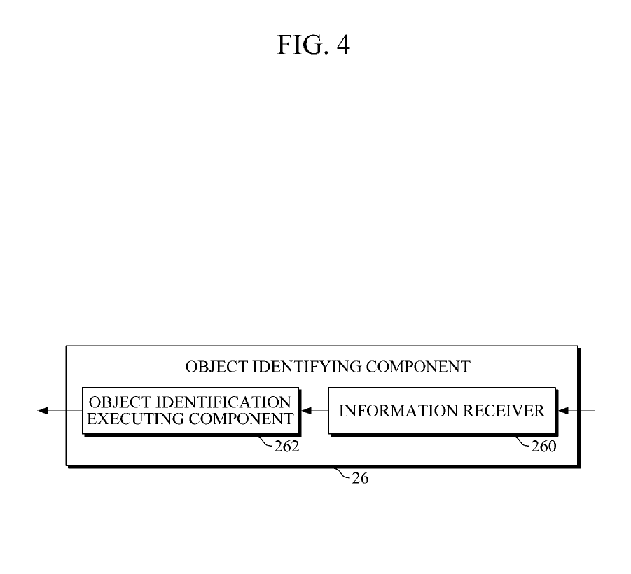

The object identifying component 26 receives the object-detection result from the object detecting component 24, and the image-object correlation information from the information-processing component 22. Then, the object identifying component 26 identifies a target object in the image using the received object-detection result and image-object correlation information. The object identifying component 26 may provide the object recognition result to an object recognition requester 400. Configuration and operation of the object identifying component 26 will be further described in detail with reference to FIG. 4.

FIG. 3 is a diagram illustrating in detail the information-processing component of FIG. 2.

Referring to FIGS. 2 and 3, the information-processing component 22 includes a data collector 220, an information generator 222, and an information provider 224.

The data collector 220 collects image-object correlation data. The image-object correlation data includes data related to an image and data related to objects that are likely to be present in the image. For example, the image-object correlation data includes, but is not limited to, a title of an image (video), the characters and objects, content information of the image, and information about various objects that are likely to be present in the image. The data collector 220 may collect the image-object correlation data from external resources through, for example, websites or various image-related information-storing entities.

The information generator 222 may process the image-object correlation data collected by the data collector 220 to generate image-object correlation information such that it can be used for object identification, and may store the generated information therein. The image-object correlation information includes separate image and object information, such as information about an image for object recognition, information about objects present in an image, and probability information about the probability of an object being present in an image, and the correlation between an image and an object. The image-object correlation information may be reflected in object identifiers for object identification. The object identifier is a value that allows an object to be distinguished from other objects. The object identifiers may be stored in the database.

For example, from the fact that an image that includes an object of interest to be recognized is part of a particular content, information about a person present in the content is used as image-object correlation information for object identification. In this example, for object identification, persons of interest to be identified in an image may be limited to persons present in the corresponding content, or a person who is identified as a character of the content may be given a weight, for example, an additional score, so that the object identification result can be adjusted.

The information provider 224 provides the image-object correlation information generated by the information generator 222 to the object identifying component 26. In one example, the information provider 224 may select image-object correlation information, which is needed by the object identifying component 26 for object identification from among the image-object correlation information generated by the information generator 222. To this end, the information provider 224 may select image-object correlation information to be provided to the object identifying component 26 using the image metadata acquired from the image acquiring component 20 and the object detection result acquired from the object detecting component 24.

FIG. 4 is a diagram illustrating in detail the object identifying component of FIG. 2.

Referring to FIGS. 2 and 4, the object identifying component 26 includes an information receiver 260 and an object identification executing component 262.

The information receiver 260 receives the image-object correlation information from the information processing component 22, and processes the received information in such a manner that can be used by the object identification executing component 262. The object identification executing component 262 identifies the object using the object identifiers and the image-object correlation information.

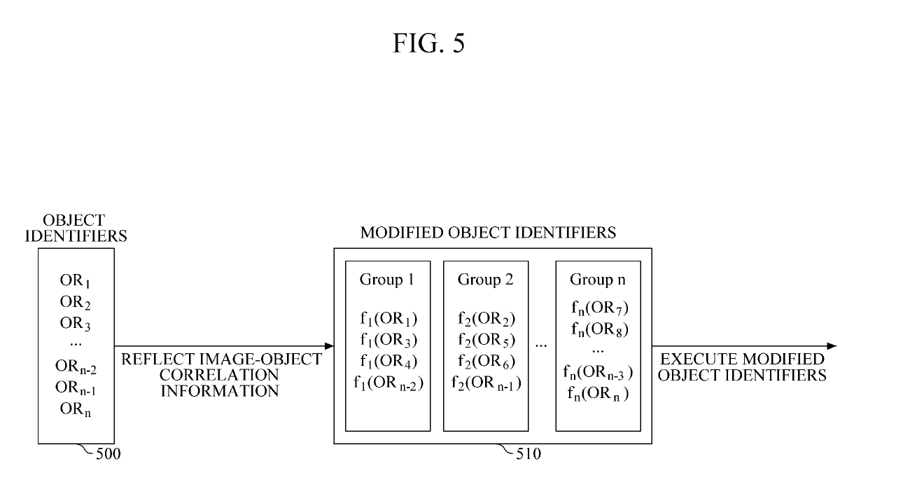

In one example, the information receiver 260 receives the image-object correlation information provided from the information processing component 22, and modifies the object identifiers to reflect the received image-object correlation information. The object identification executing component 262 identifies the target object using the modified object identifier. This process will be described below with reference to FIG. 5.

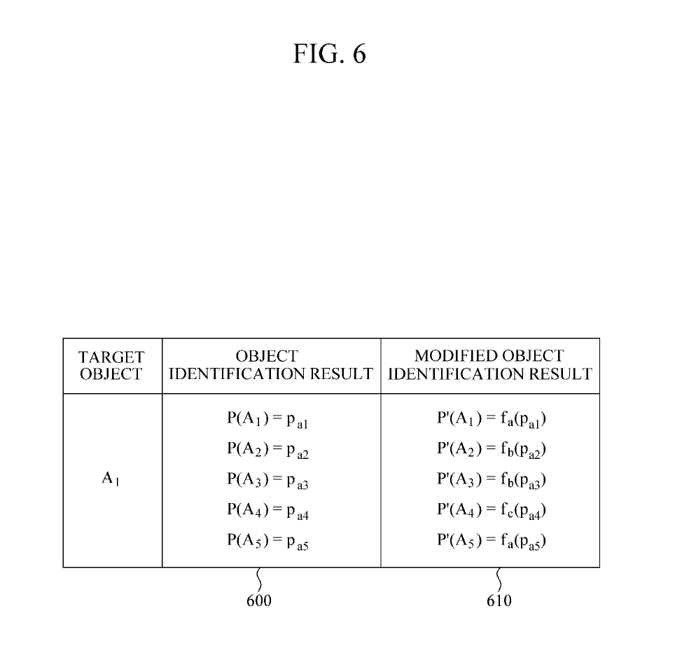

In another example, the object identification executing component 262 identifies an object using object identifiers possessed by the apparatus 2 for identifying an object. The information receiver 260 receives the image-object correlation information provided by the information-processing component 22, and produces a final identification result by adjusting the object identification result to reflect the received image-object correlation information. This process will be described in detail below with reference to FIG. 6.

FIG. 5 is a diagram to explain an example of object identification by modifying object identifiers using image-object correlation information according to an exemplary embodiment.

Referring to FIG. 5, in the process of object identification, object identifiers 500 possessed by an object identification apparatus are modified to reflect image-object correlation information. Modified object identifiers 510 may be classified into various groups (Group 1, Group 2, . . . , and Group N) according to the image-object correlation information. Classifying the object identifiers 500 into groups is not limited to any specific method.

For example, if image-object correlation information is reflected in object identifiers of persons using information about persons present in an image, the object identifiers of main characters may be classified as Group 1, object identifiers of supporting characters may be classified as Group 2, and the remaining object identifiers may be classified as Group 3. Each group may include no object identifier or multiple object identifiers.

The object identifiers in each group may be mathematically modeled by applying a new function. For example, as shown in FIG. 5, f₁(x) is applied to Group 1, f₂(x) is applied to Group 2, and fₙ(x) is applied to Group N.

Object identifiers to which the new functions are applied based on image-object correlation information may be utilized in various ways to produce an actual result of object identification. In one example, first, only the object identifiers belonging to Group 1 are used for object identification, and if it fails to obtain an appropriate result from the first object identification process, further object identification is performed using the object identifiers belonging to Group 2. In the same manner, the object identification is performed sequentially using the object identifiers belonging to each group, up to Group n, until an appropriate result is obtained. In this case, accuracy of object identification may be improved.

In another example, object identification is performed only using the object identifiers belonging to Group 1, and a final object-identification result is confined to outcomes of this object identification process using the Group 1 object identifiers, so that the object identifiers belonging to Group 2 and others do not need to be used. In this example, a range of target objects is limited, so that the number of operations needed for object identification is reduced, thereby increasing identification speed.

FIG. 6 is a diagram explaining an example of a result of object identification using object identifiers modified using image-object correlation information according to exemplary embodiment.

Referring to FIG. 6, target object A1 is identified using object identifiers, which produces the identification results 600. In order to use image-object correlation information in the process of object identification, it is determined to which group each of target object candidates A1 to A5 belongs. For example, if target object candidates A1, A2, A3, A4, and A5 belong to Group a, Group b, Group b, Group c, and Group a, respectively, functions fₐ(x), f_{b}(x), and f_{c}(x) that are to be combined with each object identifier belonging to associated groups are applied to the initial object-identification results 600 to produce modified object-identification results 610.

Importance of each object identifier can be differentiated from one another by reflecting the image-object correlation information to an object identifier set that the apparatus for recognizing an object retains. In other words, in the process of object identification, the image-object correlation information may limit target objects to be identified, or provide information about an object that is highly likely to be identified, thereby making it possible to increase speed and accuracy of object identification.

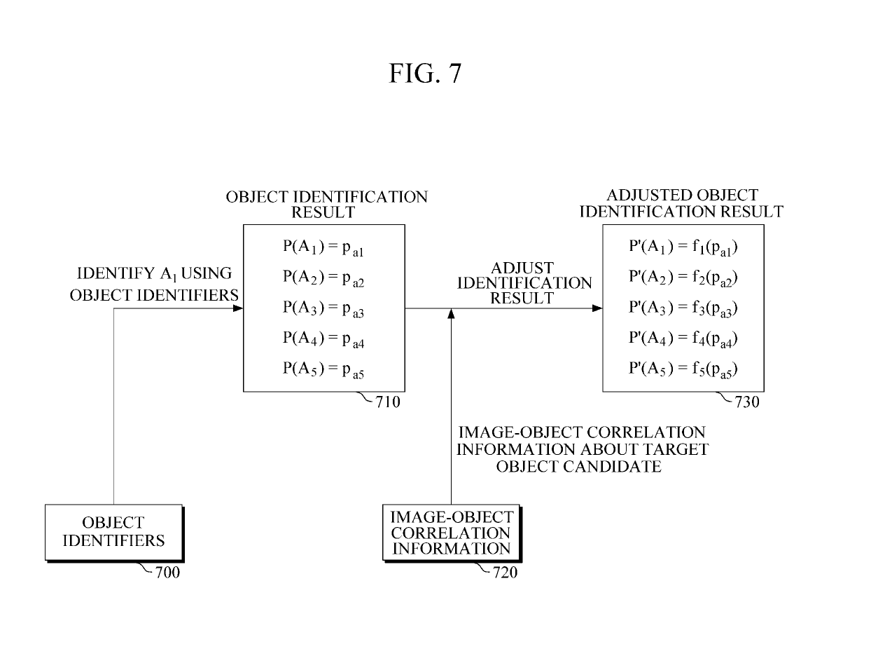

In another example, if an image containing target objects is a part of historical drama content, a function to lower a likelihood of an object being identified may be applied to a modern object in the image. This process will be described below with reference to FIG. 7.

FIG. 7 is a diagram explaining an example of adjusting an object-recognition result using image-object correlation information according to an exemplary embodiment.

Referring to FIG. 7, target object A1 is identified using object identifiers 700 to produce object-identification results 710. Then, image-object correlation data of an image containing target object A1 is obtained, and image-object correlation information is generated from the obtained image-object correlation data. At this time, the corresponding image and image-object correlation information 720 associated with content of the image is selected from image-object correlation information possessed by an object recognition apparatus. A final object-identification result 730 is produced by adjusting the initial object-identification result 710 to reflect the selected image-object correlation information 720.

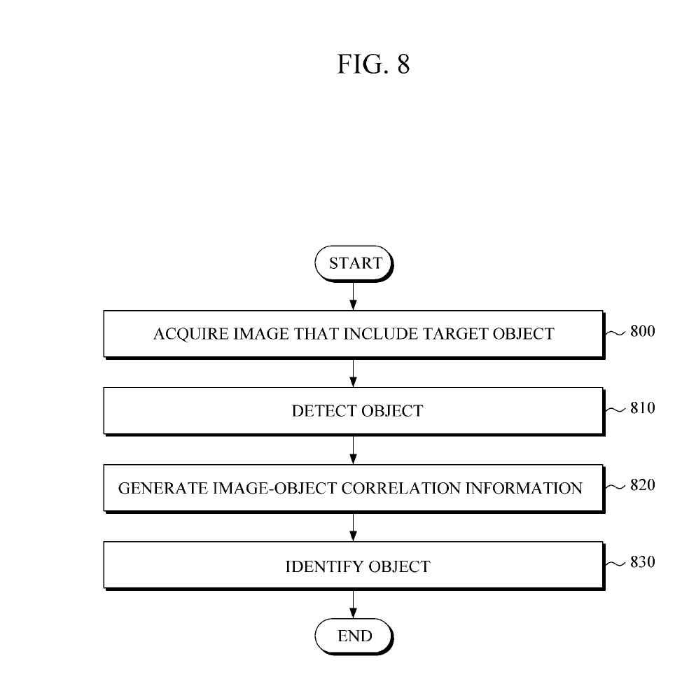

FIG. 8 is a flowchart illustrating a method for recognizing an object according to an exemplary embodiment.

Referring to FIG. 8, an apparatus for recognizing an object acquires an image containing target objects in 800. Then, the apparatus detects objects from the acquired image in 810.

Thereafter, the apparatus generates image-object correlation information that represents a correlation between the image and each object in 820. The image-object correlation information is information generated from data about an image and data about objects present in the image, and includes image-related information, object information about an object likely to be present in the image, probability information about a likelihood of a predetermined object being present in a predetermined image, and the like.

In 820, more specifically, the apparatus collects data about the image and data about each object in the image, and generates the image-object correlation information by processing the collected data about the image and the objects. Then, the apparatus provides the generated image-object correlation information.

In 820, in another example, the apparatus may select image-object correlation information required for object identification from among previously stored image-object correlation information, and provides the selected image-object correlation information. In this example, the apparatus may receive both image metadata of the image containing target objects and the result of object detection, and select the image-object correlation information using the received image metadata and result of object detection.

Then, the apparatus identifies the target object using the result of object detection and image-object correlation information in 830. More specifically, in 830, the apparatus receives image-object correlation information, modifies object identifiers to reflect the received image-object correlation information, and identifies the target object using the modified object identifiers. In 830, the apparatus in accordance with another exemplary embodiment may identify an object using the object identifiers, receive image-object correlation information, and produce a final object-identification result by adjusting an object-identification result to reflect the received image-object correlation information.

According to the above exemplary embodiments, it is possible to efficiently recognize objects in an image. In the process of object recognition, the object identification performance can be increased by use of image-object correlation information, which is generated using information about an image with a target object and information about the object, as well as previously learned identification models. The range of objects of interest to be identified may be limited, so that the number of needed operations is reduced, and thereby the identification speed can be increased. In addition, the identification accuracy can be improved by adjusting an identification result to reflect a likelihood of a target object being present in an image.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for recognizing an object, comprising:
an input component configured to receive an input image including a target object; and
a processor configured to recognize a target object in the received image using image-object correlation information that represents a correlation between an image and an object.

2. The apparatus of claim 1, wherein the image-object correlation information is information generated from data about an image and data about an object in the image, and includes image-related information, object information about an object likely to be present in an image, and probability information about a likelihood of a predetermined object being present in a predetermined image.

3. The apparatus of claim 1, wherein the processor limits a range of a target object based on the image-object correlation information.

4. The apparatus of claim 1, wherein the processor modifies object identifiers to reflect image-object correlation information and identifies the target object in the image using the modified object identifiers.

5. The apparatus of claim 1, wherein the processor adjusts an object-identification result to reflect the image-object correlation information.

6. The apparatus of claim 5, wherein the processor identifies the target object using the object identifiers, and produces a final object-identification result by adjusting the object-identification result to reflect the image-object correlation information.

7. The apparatus of claim 1, wherein the processor models the object identifiers into a plurality of groups using the image-object correlation information.

8. The apparatus of claim 7, wherein the processor differentiates importance of the groups from one another, and identifies the target object sequentially using object identifiers of each group according to priority of groups.

9. The apparatus of claim 7, wherein the processor differentiates importance of the groups from one another, and identifies the target object in a constrained manner that only uses object identifiers belonging to a designated group.

10. The apparatus of claim 1, wherein the processor determines the image-object correlation information using both image metadata of the image with the target object and a result of object detection.

11. An apparatus for recognizing an object, comprising:
an image acquiring component configured to acquire an image that includes a target object;
an object detecting component configured to detect an object in the image acquired by the image acquiring component;
an information-processing component configured to acquire data about an image and data about an object in the image and generate image-object correlation information that represents a correlation between the image and an object; and
an object identifying component configured to receive an object-detection result from the object detecting component, receive the image-object correlation information from the information-processing component, and identify the target object using the received object-detection result and image-object correlation information.

12. The apparatus of claim 11, wherein the information-processing component comprises a data collector configured to collect data about an image and data about an object in the image, an information generator configured to generate the image-object correlation information by processing the data collected by the data collector, and an information provider configured to provide the generated image-object correlation information to the object identifying component.

13. The apparatus of claim 11, wherein the image-object correlation information is generated from data about an image and data about an object in the image, and includes image-related information, object information about an object likely to be present in an image, and probability information about a likelihood of a predetermined object being present in a predetermined image.

14. The apparatus of claim 11, wherein the information processing component selects image-object correlation information needed for object identification by the object identifying component from among previously stored image-object correlation information, and provides the selected image-object correlation information to the object identifying component.

15. The apparatus of claim 14, wherein the information processing component receives image metadata of the image that includes the target object from the image acquiring component, receives the object-detection result from the object detecting component, and selects the image-object correlation information to be provided to the object identifying component using the received image metadata and image-object correlation information.

16. The apparatus of claim 11, wherein the object identifying component comprises an information receiver configured to receive the image-object correlation information from the information processing component and modify object identifiers to reflect the received image-object correlation information and an object identification executing component to identify the target object using the object identifiers modified by the information receiver.

17. The apparatus of claim 11, wherein the object identifying component comprises an object identification executing component configured to identify an object using object identifiers, and an information receiver configured to receive the image-object correlation information from the information processing component and produce a final identification result by adjusting an object identification result from the object identification executing component to reflect the received image-object correlation information.

18. A method of recognizing an object, comprising:
acquiring an image that includes a target object;
detecting an object in the acquired image;
generating image-object correlation information that represents a correlation between an image and an object; and
identifying the target object using an object detection result and the image-object correlation information.

19. The method of claim 18, wherein the identifying of the target object comprises receiving the image-correlation information, modifying object identifiers to reflect the received image-object correlation information and identifying the target object using the modified object identifiers.

20. The method of claim 18, wherein the identifying of the target object comprises identifying objects in the image using object identifiers, receiving the image-object correlation information, and producing a final identification result by adjusting an object identification result to reflect the received image-object correlation information.
